(19) United States
(12) Patent Application Publication
(10) Pub. No.: US 2014/0135117 A1
(43) Pub. Date: May 15, 2014

(54) STORAGE MEDIUM HAVING STORED THEREIN GAME PROGRAM, GAME APPARATUS, GAME SYSTEM, AND GAME PROCESSING METHOD

(71) Applicant: NINTENDO CO., LTD., Kyoto (JP)

(72) Inventors: Goro ABE, Kyoto (JP); Takehiko Hosokawa, Kyoto (JP)

(73) Assignee: NINTENDO CO., LTD., Kyoto (JP)

(21) Appl. No.: 13/867,426

(22) Filed: Apr. 22, 2013

(30) Foreign Application Priority Data
Nov. 15, 2012 (JP) 2012-251034

(51) Int. Cl. A63F 13/00

(52) U.S. Cl. CPC A63F 13/00
USPC 463/31

(57) ABSTRACT

Game images are displayed at least on a portable first display device and a second display device different from the first display device, respectively. A first game image of a game space seen form a first-person viewpoint of a player object positioned in the game space and a second game image of the game space seen from a fixed predetermined viewpoint are generated, and the first game image and the second game image are displayed on the first display device and the second display device, respectively.

### CROSS REFERENCE TO RELATED APPLICATION

The disclosures of Japanese Patent Application No. 2012-251034, filed on Nov. 15, 2012, are incorporated herein by reference.

### FIELD

The technology shown here relates to a storage medium having stored therein a game program, a game apparatus, a game system, and a game processing method, and more particularly relates to, for example, a storage medium having stored therein a game program, a game apparatus, a game system, and a game processing method for displaying game images seen from different viewpoints on a plurality of display devices, respectively.

### BACKGROUND AND SUMMARY

Conventionally, there is a game which is operated by a user holding a hand-held game apparatus and in which a game screen is displayed in accordance with the user's operation performed on the hand-held game apparatus. The hand-held game apparatus generates game images based on various operations performed by the user on an operation key, a touch panel, and the like, and advances a game while displaying the game images on a display unit provided in the hand-held game apparatus.

However, the above described hand-held game apparatus merely displays a game image based on a direction predetermined with respect to the display unit provided in the hand-held game apparatus. Thus, a game image of a display orientation that the user desires cannot be displayed.

Therefore, an objective of the exemplary embodiment is to provide a storage medium having stored therein a game program, a game apparatus, a game system, and a game processing method which can, when displaying game images on a plurality of display devices including a portable display device, display appropriate images on the display devices, respectively.

In order to achieve the above objective, the exemplary embodiment has, for example, the following features. It should be understood that the scope of the present invention is interpreted only by the scope of the claims. In event of any conflict between the scope of the claims and the scope of the description in this section, the scope of the claims has priority.

One configuration example of the exemplary embodiment is a computer-readable storage medium having stored therein a game program to be executed by a computer included in an apparatus which displays game images at least on a portable first display device and a second display device different from the first display device, respectively. The game program causes the computer to execute: generating a first game image of a game space seen from a first-person viewpoint of a player object positioned in the game space; generating a second game image of the game space seen from a fixed predetermined viewpoint in the game space; displaying the first game image on the first display device; and displaying the second game image on the second display device.

According to the above, game images appropriate for a plurality of display devices including a portable display device can be displayed, respectively. For example, the first game image of the game space seen from the first-person viewpoint is displayed on the portable first display device, and thereby a user holding the first display device can see the game space from the viewpoint of the player object. Meanwhile, on the second display device, the second game image of the same game space seen from the fixed viewpoint is displayed, and thereby the user can see the game space from the same viewpoint all the time, which allows the user not to be aware of the game space.

Further, the first display device may include a sensor which outputs data in accordance with a movement or an orientation of the first display device. In this case, when the first game image is generated, at least a view direction in which the game space is seen from the first-person viewpoint may be set in accordance with the orientation of the first display device calculated based on the data outputted from the sensor.

According to the above, the view direction of the game image displayed on the first display device is changed in accordance with the orientation of the first display device, thereby allowing the user holding the first display device to feel as if he/she is actually in the game space.

Further, the first display device may further include an operation unit having a direction instruction unit for performing a direction instruction based on an operation by a user. In this case, when the first game image is generated, the view direction can be set in which the game space is seen from the first-person viewpoint in accordance with a direction instruction operation performed on the direction instruction unit. When the first game image is generated, selection may be made to perform one of: setting the view direction in accordance with the orientation of the first display device based on the operation performed on the operation unit; and setting the view direction in accordance with the direction instruction operation. It should be noted that the operation unit operated for making the selection to perform one of: setting the view direction in accordance with the orientation of the first display device; and setting the view direction based on the direction instruction operation may be an operation unit different from the direction instruction unit or may be the same operation unit as the direction instruction unit.

According to the above, the view direction of the game image displayed on the first display device is changed by an operation performed using the direction instruction unit provided in the first display device, thereby allowing variations in operations and also allowing the user to select an operation for changing the view direction.

The first display device may include a direction instruction unit for performing a direction instruction based on an operation of a user. In this case, when the first game image is generated, at least a view direction may be set in which the game space is seen from the first-person viewpoint in accordance with a direction instruction operation performed on the direction instruction unit.

According to the above, the view direction of the game image displayed on the first display device is changed by an operation performed using the direction instruction unit provided in the first display device, which is appropriate for an operation of looking at a predetermined position in the game space.

Further, the first display device may include a first speaker. The game program may further cause the computer to execute: generating an ambient sound around the player object in the game space based on a position and/or a direction of the player object in the game space; and controlling so that the generated ambient sound is outputted from the first speaker.

According to the above, the first game image of the game space seen from the first-person viewpoint of the player object is displayed on the portable first display device and simultaneously the sounds generated around the player object are outputted from the first display device, thereby allowing the user to feel as if he/she is actually in the game space.

The second display device may be a stationary display device. When the second game image is generated, an image of the entire game space seen from the fixed viewpoint may be generated as the second game image.

According to the above, the second game image of the entire same game space seen from the fixed viewpoint is displayed on the stationary display device. Thus, the user can see the entire game space always from the same viewpoint by looking at the display device which is positioned always at the same position, thereby the user can more easily recognize the game space.

When the second game image is generated, an image of the game space including the player object may be generated as the second game image.

According to the above, an appearance and a state of the player object can be seen using the second game image

Further, the first display device may include a sensor which outputs data in accordance with a movement or an orientation of the first display device. The computer may be further caused to execute changing the position or the orientation of the player object in accordance with the movement or the orientation of the first display device calculated based on the data outputted from the sensor. In this case, when the second game image is generated, an image of the game space including the player object positioned in the game space in accordance with the position or the orientation having been changed may be generated as the second game image.

According to the above, the state of the player object changed in accordance with the movement or the orientation of the first display device can be seen using the second game image.

The first display device may include a direction instruction unit for performing a direction instruction based on an operation of a user. The computer may be further caused to execute changing the position or the orientation of the player object in accordance with a direction instruction performed using the direction instruction unit. In this case, when the second game image is generated, an image of the game space including the player object positioned in the game space in accordance with the position or the orientation having been changed may be generated as the second game image.

According to the above, the state of the player object changed in accordance with the direction instruction operation can be seen using the second game image.

The second display device may include a second speaker. The game program may further cause the computer to execute: generating a whole sound generated in the whole game space; and controlling so that the generated whole sound is outputted from the second speaker.

According to the above, the second game image of the entire game space seen from the fixed viewpoint is displayed on the stationary second display device, and simultaneously sounds generated in the whole game space are outputted from the second display device. Consequently, the game space displayed on the second display device can be expressed more realistically.

Further, the first-person viewpoint may be a viewpoint from which the player object sees.

Further, the exemplary embodiment may be implemented in the form of a game apparatus or a game system including units for performing the respective operations, or in the form of a game processing method including the respective operations.

According to the exemplary embodiment, game images appropriate for a plurality of display devices including a portable display device can be displayed, respectively.

These and other objects, features, aspects and advantages of the exemplary embodiment will become more apparent from the following detailed description when taken in conjunction with the accompanying drawings.

### BRIEF DESCRIPTION OF THE DRAWINGS

FIG. 1 is a block diagram showing a non-limiting example of an information processing system 1;

FIG. 2 shows a non-limiting example of an image (game image) displayed on the information processing system 1;

FIG. 3 shows a non-limiting example of an entire image of a virtual game space displayed on a monitor 4;

FIG. 4 shows a non-limiting example of a game image seen from a first-person viewpoint based on which a direction of a player object (view direction) is controlled in accordance with an orientation of a terminal device 2;

FIG. 5 shows a non-limiting example of a game image seen from the first-person viewpoint based on which the direction of the player object (view direction) is controlled in accordance with an operation by an operation unit 13 (direction instruction unit);

FIG. 6 shows a non-limiting example of data and programs stored in a memory 6 of an information processing apparatus 3;

FIG. 7 is a flow chart showing a non-limiting example of processing performed by the information processing apparatus 3; and

FIG. 8 is a subroutine showing a non-limiting example of an initialization process performed in step 61 of FIG. 7.

### DETAILED DESCRIPTION OF NON-LIMITING EXAMPLE EMBODIMENTS

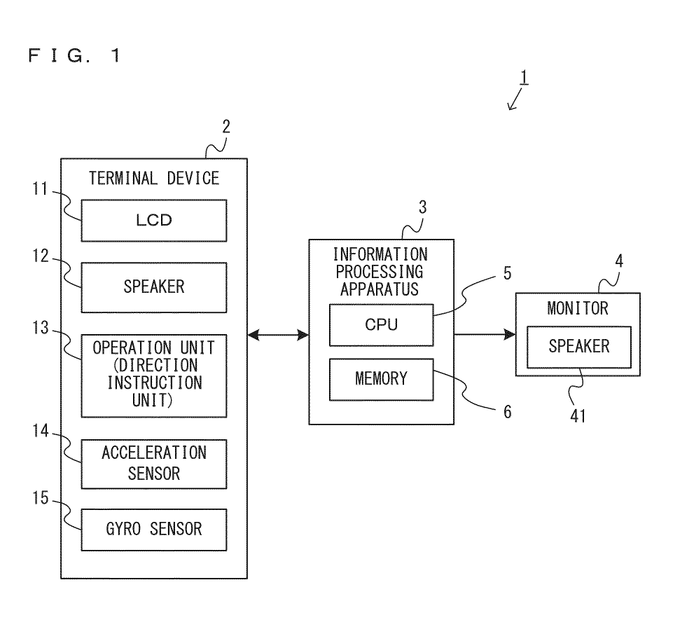

With reference to FIG. 1, an information processing apparatus according to one exemplary embodiment which executes a game program and an information processing system including the information processing apparatus will be described. FIG. 1 is a block diagram showing an example of an information processing system 1 including an information processing apparatus 3. As one example, the information processing apparatus 3 is implemented as a stationary game apparatus and the information processing system 1 is implemented as a game system including the game apparatus.

In FIG. 1, the information processing system 1 includes a terminal device 2, the information processing apparatus 3, and a monitor 4. In the information processing system 1 of the exemplary embodiment, images (game images) are generated and displayed on display devices (the terminal device 2 and the monitor 4).

In the information processing system 1, the information processing apparatus 3 performs information processing in accordance with an input performed on the terminal device 2 and an image obtained as a result of the processing having been performed is displayed on the terminal device 2 and/or the monitor 4. Accordingly, in the exemplary embodiment, the information processing system 1 is implemented as a plurality of apparatuses which realize an input function, an information processing function, and a display function. In another exemplary embodiment, the information processing system 1 may be implemented as a single information processing apparatus (e.g., a hand-held or portable information processing apparatus) having these functions.

The terminal device 2 is an (portable) input device that can be held by a user. The terminal device 2 is communicable with the information processing apparatus 3. The terminal device 2 transmits operation data representing an operation performed on the terminal device 2 to the information processing apparatus 3. Further, in the exemplary embodiment, the terminal device 2 is provided with a display unit (LCD 11), and the terminal device 2 is also a display device. When an image is transmitted from the information processing apparatus 3, the terminal device 2 displays the image on the LCD 11.

Further, the terminal device 2 is provided with a speaker 12, and the terminal device 2 is also a display device and a sound output device. The speaker 12 is, for example, a pair of stereo speakers, whose output may be controlled by a sound IC that is a circuit for controlling an output of sound data. When a sound is transmitted from the information processing apparatus 3, the terminal device 2 outputs the sound from the speaker 12 via the sound IC.

Further, the terminal device 2 is provided with an operation unit 13 as an input unit. As one example, the operation unit 13 is provided with a direction instruction unit including an analog stick, a cross key, and the like. The direction instruction unit may be implemented as a touch panel or a touch-pad which detects a position inputted on a predetermined input surface (e.g., a screen of a display unit) provided on a housing. For example, the touch panel or the touch-pad can indicate a direction based on a direction of a touch operation performed on the touch panel or the touch-pad with respect to a reference position on the input surface (e.g., the center of the input surface). Moreover, the operation unit 13 is provided with operation buttons and the like.

Further, the terminal device 2 is provided with an acceleration sensor 14 as an input unit. The acceleration sensor 14 detects accelerations in predetermined axial directions (three axial directions in the exemplary embodiment, but may be one or more axial directions) of the terminal device 2. Further, the terminal device 2 is provided with a gyro sensor 15 as an input unit. The gyro sensor 15 detects angular velocities of rotation about predetermined axial directions (three axial directions in the exemplary embodiment, but may be one or more axial directions) of the terminal device 2 as axes. The acceleration sensor 14 and the gyro sensor 15 are each a sensor which detects information for calculating an orientation (information for calculating or estimating an orientation) of the terminal device 2. It should be noted that, in another exemplary embodiment, the orientation of the terminal device 2 may be calculated based on any method, and may be calculated by using a sensor other than the above sensors or a camera capable of capturing the terminal device 2.

The information processing apparatus 3 performs various information processes such as an image generating process, which are performed in the information processing system 1. In the exemplary embodiment, the information processing apparatus 3 includes a CPU (control unit) 5 and the memory 6, and various functions in the information processing apparatus 3 are realized by the CPU 5 executing a predetermined information processing program (e.g., a game program) by using the memory 6. It should be noted that the information processing apparatus 3 may have any configuration as long as it can perform the above information processes. In the exemplary embodiment, an image (game image) is generated by the information processing apparatus 3 and the generated image is outputted to the terminal device 2 and the monitor 4 which are display devices.

The monitor 4 is one example of a display device which displays an image having been generated and a sound output device which outputs a sound having been generated. The monitor 4 can receive data transmitted from the information processing apparatus 3. When the image and the sound generated by the information processing apparatus 3 are transmitted to the monitor 4, the monitor 4 displays the image and simultaneously outputs the sound from the speaker 41.

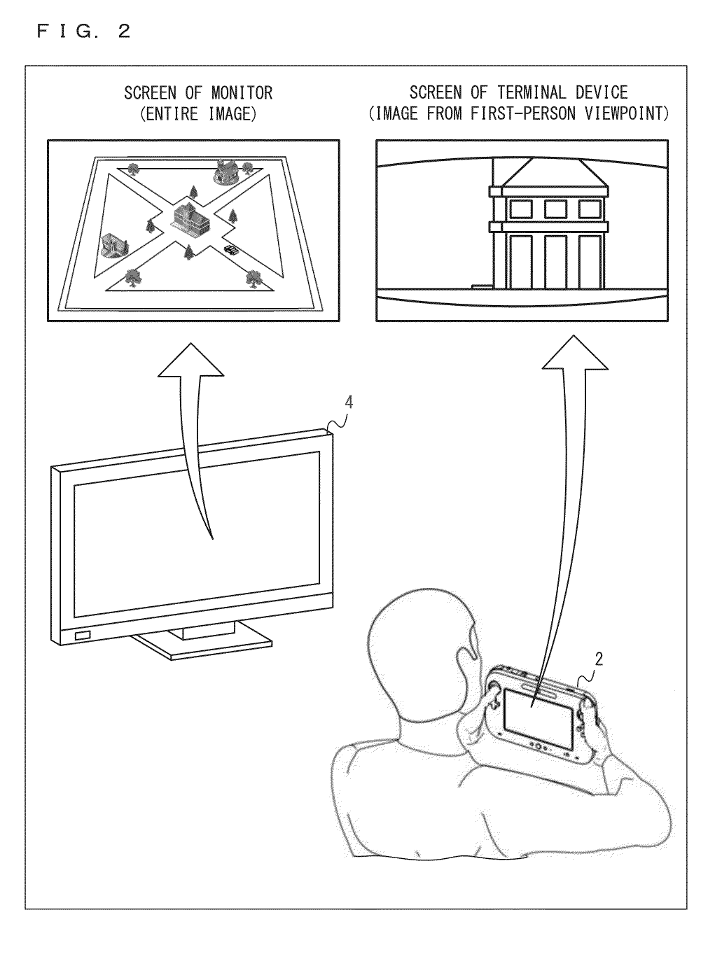

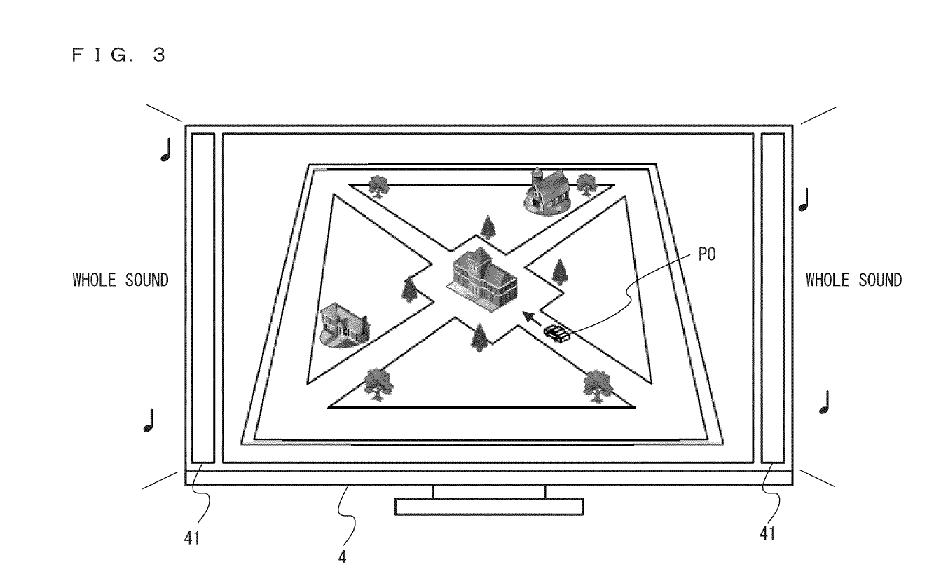

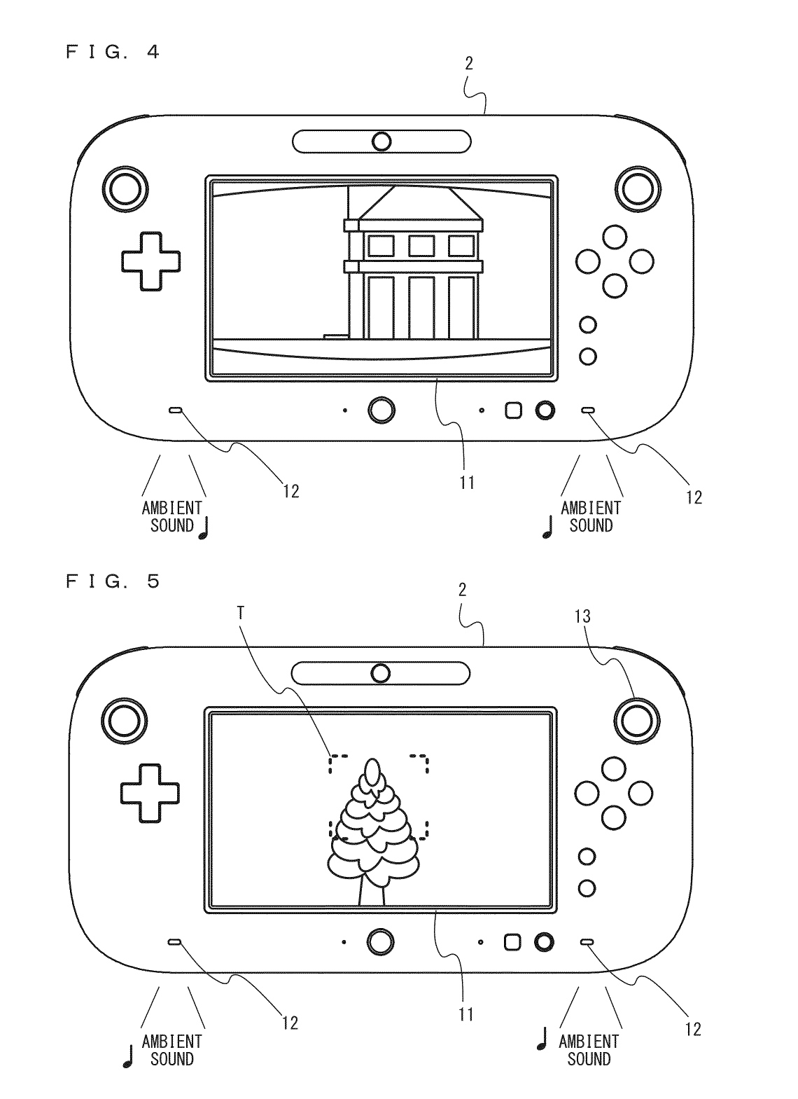

Next, before describing specific processes performed by the information processing apparatus 3, an outline of the information processes performed by the information processing apparatus 3 will be described with reference to FIG. 2 to FIG. 5. FIG. 2 shows an example of an image (game image) displayed on the information processing system 1. FIG. 3 shows an example of an entire image of a virtual game space displayed on the monitor 4. FIG. 4 shows an example of a game image seen from a first-person viewpoint based on which a direction of a player object (view direction) is controlled in accordance with an orientation of the terminal device 2. FIG. 5 shows a non-limiting example of a game image seen from the first-person viewpoint based on which the direction of the player object (view direction) is controlled in accordance with an operation by the operation unit 13 (direction instruction unit).

As shown in FIG. 2, in the exemplary embodiment, game images are displayed on the terminal device 2 and the monitor 4, respectively. For example, while holding the terminal device 2, a user changes the orientation of the terminal device 2 and operates the operation unit 13 of the terminal device 2, thereby causing a player object PO positioned in the virtual game space to move and changes a display range of the virtual game space displayed on the LCD 11 of the terminal device 2.

As shown in FIG. 2 and FIG. 3, for example, an entire image of the virtual game space is displayed on the monitor 4 with the display range and a display orientation being fixed. Here, the entire image is an image that can display the entire range in which the player object operated by the user can move in the virtual game space. In order to display the entire image fixedly, on the monitor 4, a viewpoint in the virtual game space is fixed and a view direction and a viewing angle from the viewpoint are set and fixed, such that the entire range in which the player object can move is included in the display range. Further, in the virtual game space, game sounds generated from objects positioned on a game field as respective sound sources are generated. Then, a whole sound (e.g., a sound obtained by synthesizing the game sounds generated from the respective sound sources) generated in the whole virtual game space is outputted from the speaker 41 of the monitor 4.

For example, the user can set a moving direction of the player object by operating the direction instruction unit of the operation unit 13, and move the player object in the moving direction by operating a predetermined operation button (for example, pressing an A button or a B button) included in the operation unit 13. As one example, a direction (direction in which the player object PO faces in the virtual game space) in which the player object PO moves is changed in accordance with a direction instruction of the user performed using the direction instruction unit. Specifically, when the user performs a direction instruction of a leftward direction using the direction instruction unit, the direction in which the player object PO faces is changed to the leftward direction seen from the player object PO, and the moving direction of the player object PO is changed to the leftward direction. Further, when the user performs a direction instruction of a rightward direction using the direction instruction unit, the direction in which the player object PO faces is changed to a rightward direction seen from the player object PO, and the moving direction of the player object PO is changed to the rightward direction. In the exemplary embodiment, an example is used where the player object PO in a vehicle (e.g., a car) moves on the game field. Thus, in this case, a direction (moving direction) of the vehicle changes in accordance with a direction of the terminal device 2, and a direction (range of view) of the player object PO in the vehicle changes accordingly.

Meanwhile, as shown in FIG. 2, FIG. 4, and FIG. 5, an image of the virtual game space seen from the player object PO (image seen from a first-person viewpoint of the player object PO) positioned in the virtual game space is displayed on the LCD 11 of the terminal device 2. Then, from the speaker 12 of the terminal device 2, ambient sounds generated around the player object PO (for example, game sounds generated from the sound sources positioned in a range predetermined with respect to the player object PO) in the virtual game space. In the example shown in FIG. 4, from the player object PO in the vehicle as a viewpoint, a virtual camera is set with a direction of the player object PO as a view direction thereof, and a status in the virtual game space seen from the virtual camera is displayed. Accordingly, by displaying the image seen from the first-person viewpoint of the player object PO on the LCD 11, the user holding the terminal device 2 can feel as if he/she is actually in the virtual game space and the user can intuitively recognize the moving direction and a movement speed of the player object PO. Further, by associating the direction of the terminal device 2 with a direction and a position of the virtual camera and changing the ambient sounds around the player object PO outputted from the terminal device 2 accordingly, the user can feel as if he/she himself/herself is the player object PO and is peeping into the virtual game space via the LCD 11 of the terminal device 2. Moreover, by operating the direction instruction unit of the terminal device 2, the user can feel as if he/she is controlling the vehicle carrying the player object PO by remote control and enjoy the scenery which can be seen from the vehicle.

As another example of controlling movement of the player object PO, for example, the user can change the direction of the player object PO based on a direction in which the terminal device 2 faces (orientation of the terminal device 2) while operating the predetermined operation unit 13 (for example, pressing an L button). As described above, in the exemplary embodiment, an example is used where the player object PO in the vehicle moves on the game field. In this case, in the example of the above movement control, only the direction (range of view) of the player object PO is changed while the vehicle is stopped and the direction thereof remains unchanged. As one example, by the user directing the terminal device 2 in up/down and left/right directions (i.e., pitch and yaw), the direction in which the player object PO faces in the virtual game space is changed in accordance with change in the direction. Specifically, when the user changes the direction of the terminal device 2 such that a back surface of the terminal device 2 faces in the leftward direction (that is, when the terminal device 2 is yawed in the leftward direction), the direction of the player object PO is changed to the leftward direction of the virtual game space. Further, when the user changes the direction of the terminal device 2 such that the back surface of the terminal device 2 faces in the upward direction (that is, when the terminal device 2 is pitched to the upward direction), the direction of the player object PO is changed to the upward direction of the virtual game space.

In another example of controlling the movement of the player object PO, an image of the virtual game space seen from the player object PO (image seen from the first-person viewpoint of the player object PO) is displayed on the LCD 11 of the terminal device 2. Then, ambient sounds generated around the player object PO in the virtual game space are outputted from the speaker 12 of the terminal device 2. In the example shown in FIG. 5, from the player object PO which is looking outside from the stopped vehicle as a viewpoint, the virtual camera is set with the player object PO as a view direction, and a status in the virtual game space seen from the virtual camera is displayed. Further, in the example shown in FIG. 5, a shooting aim T of the player object PO for attacking another object is displayed at or near the center of the display screen. By operating the predetermined operation unit 13 (for example, pressing a R button) while the shooting aim T is being displayed, the user can attack another object positioned in a direction of the virtual game space (for example, launches a cannonball or a light beam in the direction) in accordance with the shooting aim T. Accordingly, the view direction is changed in accordance with the orientation of the terminal device 2 while the image seen from the first-person viewpoint of the player object PO is being displayed on the LCD 11, thereby allowing the user holding the terminal device 2 to feel as if he/she is actually in the virtual game space. Further, because there is a plurality of operation methods of changing a display range of the LCD 11 of the terminal device 2, the user can select an operation method appropriate for him/her and cause a desired game image to be displayed.

Also, in another example of controlling the movement of the player object PO, the direction of the player object PO may be further changed by operating the direction instruction unit of the operation unit 13. In this case, the user can change the direction of the player object PO in accordance with the direction in which the terminal device 2 faces while operating the predetermined operation unit 13. Moreover, the user can also change the direction of the player object PO by operating the direction instruction unit while operating the predetermined operation unit 13. Thus, when the user performs an operation of such as aiming at a certain point (for example, operation such as setting a target for attack) in the virtual game space, the user can adjust a precise direction by the operation of the direction instruction unit while changing a rough direction by the orientation of the terminal device 2, which is suitable for the operation of such as aiming at a point.

Further, as for ambient sounds generated around the player object PO, as long as game sounds which are set as sounds generated substantially around the player object PO in the virtual game space are outputted, the ambient sounds may be generated based on any generation method. For example, a sound from a sound source positioned within a predetermined distance from the player object PO as the center, a sound from a sound source positioned within a predetermined angular range with a facing direction of the player object PO as the center, and a sound from a sound source positioned within a range (that is, a range displayed on the terminal device 2) seen from the player object PO, may be generated as the ambient sounds. Further, the above described generation methods of the ambient sounds may be used in combination to generate the ambient sounds.

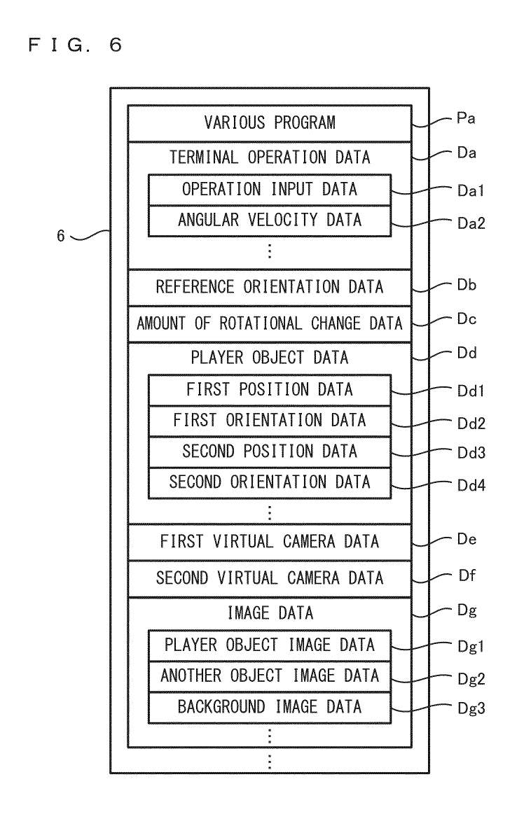

Next, the processing (e.g., a game process) performed by the information processing apparatus 3 will be described in detail. In the following description of the processing, an example (see FIG. 2 to FIG. 5) is used where game images of a same virtual game space seen from different viewpoints are displayed on the terminal device 2 and the monitor 4, respectively. Initially, main data used in the processing will be described with reference to FIG. 6. It should be noted that FIG. 6 shows an example of main data and programs stored in the memory 6 of the information processing apparatus 3.

As shown in FIG. 6, in a data storage area of the memory 6, terminal operation data Da, reference orientation data Db, amount of rotational change data Dc, player object data Dd, first virtual camera data De, second virtual camera data Df, image data Dg, and the like are stored. It should be noted that, in the memory 6, in addition to the data shown in FIG. 6, data necessary for the processing, such as data used in an application to be executed, may be stored. Further, in a program storage area of the memory 6, a group of various programs Pa including an information processing program (e.g., a game program) is stored.

As the terminal operation data Da, operation information (terminal operation data) is serially transmitted as transmission data from the terminal device 2 and stored, and thereby the operation information data is updated with the latest transmission data. For example, the terminal operation data Da includes operation input data Da1, angular velocity data Da2, and the like. The operation input data Da1 is data representing a content of an operation performed on the operation unit 13. The angular velocity data Da2 is data representing angular velocities generated on the terminal device 2, and is data representing angular velocities outputted from the gyro sensor 15.

The reference orientation data Db is data representing a reference orientation of the terminal device 2 in a real space. The amount of rotational change data Dc is data representing an amount of change in rotation per unit time of the terminal device 2, and is data representing, for example, an amount of rotational change (angular velocities around respective axes) around the respective axes (xyz-axes) set in the terminal device 2, from the orientation of the terminal device 2 in the previous processing.

The player object data Dd includes first position data Dd1, first orientation data Dd2, second position data Dd3, second orientation data Dd4, and the like. The first position data Dd1 and the first orientation data Dd2 are data respectively representing a position and an orientation of the player object in the virtual game space set in accordance with the orientation of the terminal device 2. The second position data Dd3 and the second orientation data Dd4 are data respectively representing a position and an orientation of the player object in the virtual game space set in accordance with an operation performed on the operation unit 13.

The first virtual camera data De and the second virtual camera data Df are data of a first virtual camera and a second virtual camera set in the virtual game space. For example, the first virtual camera data De is data of the first virtual camera for generating a game image to be displayed on the LCD 11 of the terminal device 2. The second virtual camera data Df is data of the second virtual camera for generating a game image to be displayed on the monitor 4.

The image data Dg includes player object image data Dg1, another object image data Dg2, background image data Dg3, and the like. The player object image data Dg1 is data for positioning the player object in the virtual game space and generating a game image. The another object image data Dg2 is data for positioning another object in the virtual game space and generating a game image. The background image data Dg3 is data for positioning a background in the virtual game space and generating a game image.

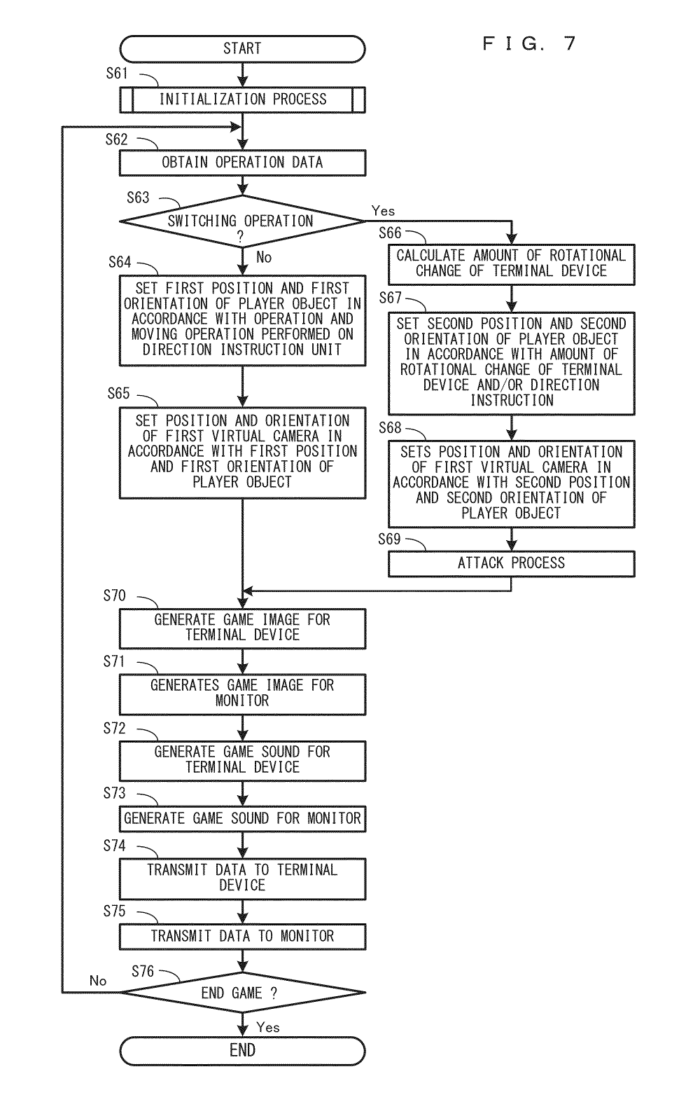

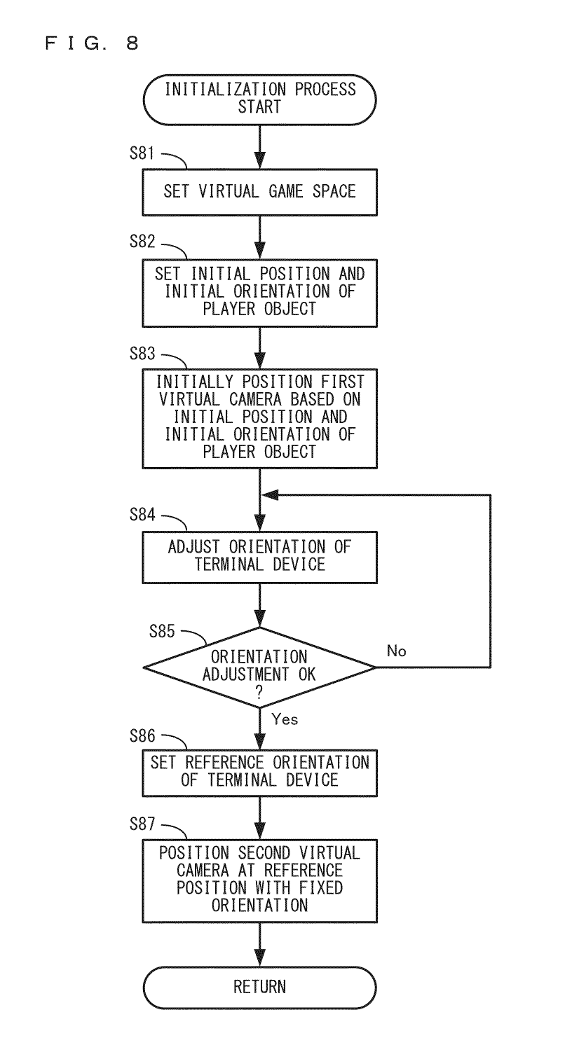

Next, the processing performed by the information processing apparatus 3 will be described in detail with reference to FIG. 7 and FIG. 8. It should be noted that FIG. 7 is a flow chart showing an example of the processing performed by the information processing apparatus 3. FIG. 8 is a subroutine showing an example of an initialization process of step 61 in FIG. 7. Here, in the flow charts shown in FIG. 7 and FIG. 8, among the processes performed by the information processing apparatus 3, mainly processes of displaying game images of a same virtual game space seen from different viewpoints on the terminal device 2 and the monitor 4, respectively, will be described, and detailed description of other processes not directly relevant to these processes will be omitted.

The CPU 5 initializes the memory 6 and the like and loads the information processing program stored in a nonvolatile memory or an optical disk in the information processing apparatus 3 into the memory 6. Then, the CPU 5 starts to execute the information processing program. The flow charts shown in FIG. 7 and FIG. 8 each show processes performed after the above process has been completed.

Processes in respective steps in the flow charts shown in FIG. 7 and FIG. 8 are only examples. The order of the process steps may be interchanged as long as similar results can be obtained. In addition to or instead of the above process steps, another process may be performed. Further, in the exemplary embodiment, the respective process steps in the flow charts are performed by the CPU 5. However, a part of or the entire process steps may be performed by a processor other than the CPU 5 or a dedicated circuit.

In FIG. 7, the CPU 5 performs an initialization process (step 61), and proceeds the processing to the next step. In the following, the initialization process performed in step 61 will be described with reference to FIG. 8.

In FIG. 8, the CPU 5 sets a virtual game space (step 81), and proceeds the processing to the next step. For example, the CPU 5 constructs a virtual game space in which a game is played in subsequent processes, and sets, in the virtual game space, a game field in which a player object PO can move about. Then, the CPU 5 sets initial positions of objects, respectively, on the game field and sets initial values for various parameters used in the game process.

Next, the CPU 5 sets an initial position and an initial orientation for initially positioning the player object PO on the game field set in step 81 (step 82), and proceeds the processing to the next step. For example, by using the initial position of the player object PO predetermined for each game field, the CPU 5 updates each of the first position data Dd1 and the second position data Dd3. Further, by using the initial orientation of the player object PO predetermined for each game field, the CPU 5 updates each of the first orientation data Dd2 and the second orientation data Dd4.

Next, the CPU 5 initially positions the first virtual camera (step 83), and proceeds the processing to the next step. For example, the CPU 5 sets, as an initial position of the first virtual camera, the position of the player object PO positioned in the virtual game space, and sets, as an initial viewing direction of the first virtual camera, the direction (facing direction) of the player object PO positioned in the virtual game space. Then, by using the initial position and the initial viewing direction of the first virtual camera having been set, the CPU 5 updates data regarding the position and the orientation of the virtual camera in the first virtual camera data De.

Next, the CPU 5 urges the user to adjust the orientation of the terminal device 2 (step 84), waits for the orientation adjustment to be performed (step 85), and repeats step 84 and step 85 until the orientation adjustment has been performed. Then, when the orientation adjustment has been performed, the CPU 5 proceeds the processing to step 86.

In step 86, the CPU 5 sets the current orientation of the terminal device 2 as the reference orientation, and proceeds the processing to the next step. For example, the CPU 5 initializes the orientation of the terminal device 2 represented by the reference orientation data Db (sets rotation amounts about respective axes to 0), and sets a reference orientation of the terminal device 2. For example, in the processes of step 84 to step 86, the orientation of the terminal device 2 at a time point when the process of step 84 has been performed or after a predetermined time period has elapsed after the time point may be set as the reference orientation, or the orientation of the terminal device 2 when the user has performed a predetermined operation may be set as the reference orientation, or a predetermined fixed orientation of the terminal device 2 may be set as the reference orientation, or the user may select one from a plurality of predetermined fixed orientations of the terminal device 2 as the reference orientation.

Next, the CPU 5 initially positions the second virtual camera (step 87), and ends the processing of the subroutine. For example, the CPU 5 sets, as a reference position and a reference orientation of the second virtual camera, a position and an orientation from which the entire game field positioned in the virtual game space can be displayed (for example, a position and an orientation from which the entire game field viewed from above is displayed). Then, the CPU 5 updates data of the position and the orientation of the virtual camera in the second virtual camera data Df using the reference position and the reference orientation of the second virtual camera having been set.

Returning back to FIG. 7, after the initialization process in step 61, the CPU 5 obtains operation data from the terminal device 2, updates the terminal operation data Da (step 62), and proceeds the processing to the next step. For example, the CPU 5 updates the operation input data Da1 and the angular velocity data Da2 using data representing a content of an operation performed on the operation unit 13 and data outputted from the gyro sensor 15, respectively.

Next, the CPU 5 determines whether a predetermined operation (switching operation) for switching an operation mode for changing the direction of the player object PO is performed (step 63). For example, the CPU 5 refers to the operation input data Da1 and determines whether the switching operation (e.g., pressing the L button in the operation unit 13) is performed. Then, when a determination result is that the switching operation is not performed, the CPU 5 proceeds the processing to step 64. When the result is that the switching operation is performed, the CPU 5 proceeds the processing to step 67.

Next, the CPU 5 sets a first position and a first orientation of the player object PO in accordance with an operation and a moving operation performed on the direction instruction unit (step 64), and proceeds the processing to the next step. For example, the CPU 5 refers to the operation input data Da1, and when an operation (e.g., pressing operation of the A button or the B button in the operation unit 13) for moving the player object PO is performed, the CPU 5 sets the moving direction of the player object PO in accordance with a direction instruction performed using the direction instruction unit (when the direction instruction is not performed, the CPU 5 sets the moving direction of the player object PO so as to move straight ahead), and at a movement speed in accordance with the moving operation, the CPU 5 moves the player object PO (e.g., a vehicle carrying the player object PO) from the position thereof set in the first position data Dd1 to the moving direction. Here, the movement speed may be set at a constant speed (in accordance with an operation button used for the moving operation, or may be set so as to accelerate to a predetermined speed in accordance with a time period during which the moving operation is continuously performed. Then, the CPU 5 sets a position and an orientation of the player object PO having been moved as a first position and a first orientation, respectively, and updates the first position data Dd1 and the first orientation data Dd2 using the first position and the first orientation. Further, in step 65, the CPU 5 copies the position of the player object PO set in the first position data Dd1 to update the second position data Dd3, and copies the orientation of the player object PO set in the first orientation data Dd2 to update the second orientation data Dd4. Meanwhile, when an operation for moving the player object PO is not performed, the CPU 5 causes the player object PO to be in a stopped state without changing the first position and the first orientation.

Next, in accordance with the first position and the first orientation, the CPU 5 sets a position and an orientation of the first virtual camera (step 65), and proceeds the processing to step 70. For example, the CPU 5 sets the position of the player object PO in the virtual game space represented by the first position data Dd1 as the position of the first virtual camera, and sets the direction (facing direction) of the player object PO represented by the first orientation data Dd2 as a view direction of the first virtual camera. Then, the CPU 5 updates data of the position and the orientation of the virtual camera in the first virtual camera data De using the position and the view direction in the first virtual camera having been set.

Meanwhile, when the switching operation is performed, the CPU 5 calculates an amount of rotational change of the terminal device 2 using the angular velocity data Da2 in step 66, and proceeds the processing to the next step. For example, in step 66, amounts of rotational change (i.e., angular velocities around respective axes) per unit time of the terminal device 2 in respective predetermined axial directions (e.g., x-axis, y-axis and z-axis directions) are calculated, and thereby the amount of rotational change data Dc is updated. It should be noted that since a rotation direction can be represented based on a positive or negative value of the rotation amount, only data representing the rotation amounts (angular velocities) around the respective axes may be stored in the amount of rotational change data Dc.

Next, in accordance with the amount of rotational change of the terminal device 2 and/or the direction instruction performed on the direction instruction unit, the CPU 5 sets a second position and a second orientation of the player object PO (step 67), and proceeds the processing to the next step. For example, the CPU 5 sets, as the second position, a position moved (for example, moved a predetermined distance in an upward direction in the virtual game space) from the first position of the player object PO represented by the first position data Dd1, and updates the second position data Dd3 using the second position. Further, the CPU 5 rotates the player object PO from the orientation thereof set in the first orientation data Dd2 for the amount of rotational change calculated in step 66 to change the orientation (direction) of the player object PO, and updates the second orientation data Dd4. Further, the CPU 5 refers to the operation input data Da1, and when the direction instruction using the direction instruction unit is performed, the CPU 5 changes the orientation (direction) of the player object PO represented by the second orientation data Dd4 to a direction corresponding to the direction instruction, and updates the second orientation data Dd4.

Next, in accordance with the second position and the second orientation, the CPU 5 sets the position and the orientation of the first virtual camera, respectively (step 68), and proceeds the processing to the next step. For example, the CPU 5 sets, as the position of the first virtual camera, the position of the player object PO in the virtual game space represented by the second position data Dd3, and sets, as the view direction of the first virtual camera, the direction (facing direction) of the player object PO represented by the second orientation data Dd4. Then, the CPU 5 updates data of the position and the orientation of the virtual camera in the first virtual camera data De using the position and the view direction of the first virtual camera having been set.

Next, the CPU 5 performs an attack process (step 69), and proceeds the processing to step 70. For example, the CPU 5 refers to the operation input data Da1, and when an operation (e.g., a pressing operation of the R button in the operation unit 13) for causing the player object PO to attack is performed, the CPU 5 performs a setting so that a predetermined attack (e.g., launching a cannonball or a light beam in an aiming direction set in the facing direction of the player object PO) in accordance with the orientation of the player object PO. Then, when the attack has been made on another object, the CPU 5 performs setting so that a predetermined damage is applied to the object.

In step 70, the CPU 5 generates a game image for terminal device to be displayed on the terminal device 2, and proceeds the processing to the next step. For example, the CPU 5 reads pieces of data representing results of the game process in step 61 to step 69, respectively, from the memory 6, reads data necessary for generating a game image for terminal device from a VRAM (Video RAM) or the like to generate a game image, and stores the generated game image for terminal device in the VRAM. For example, the game image for terminal device is generated by obtaining a three-dimensional computer graphics image by positioning the first virtual camera in the virtual game space based on the position and the orientation of the first virtual camera represented by the first virtual camera data De, positioning the player object PO in the virtual game space based on the player object data Dd (the first position data Dd1 and the first orientation data Dd2 when the switching operation is not performed, and the second position data Dd3 and the second orientation data Dd4 when the switching operation is performed), and calculating the virtual game space seen from the first virtual camera. In the exemplary embodiment, when the switching operation is performed, a game image for terminal device may be generated such that an image representing a shooting aim used in the attack operation is displayed at a predetermined position (e.g., the center of the screen) on the LCD 11 so as to overlap the game image for terminal device.

Next, the CPU 5 generates a game image for monitor to be displayed on the monitor 4 (step 71), and proceeds the processing to the next step. For example, the CPU 5 reads pieces of data representing results of the game processes in step 61 to step 69, respectively, from the memory 6, reads data necessary for generating a game image for monitor from the VRAM, to generate the game image, and stores the generated game image for monitor in the VRAM. For example, the game image for monitor is generated by obtaining a three-dimensional computer graphics image by positioning the second virtual camera in the same virtual game space where the first virtual camera is positioned based on the position and the orientation of the second virtual camera represented by the second virtual camera data Df, and calculating the virtual game space seen from the second virtual camera.

Next, the CPU 5 generates a game sound for terminal device to be outputted to the speaker 12 of the terminal device 2 (step 72), and proceeds the processing to the next step. For example, the CPU 5 generates, as a game sound for terminal device, ambient sounds generated around the player object PO based on the player object data Dd (the first position data Dd1 and the first orientation data Dd2 when the switching operation is not performed, and the second position data Dd3 and the second orientation data Dd4 when the switching operation is performed). As one example, based on the position and the direction of the player object PO in the virtual game space, the CPU 5 extracts sound sources positioned in a predetermined range in the virtual game space, and generates game sounds generated from the sound sources (voice of an object, an action sound, sound effects, and the like) as a game sound for terminal device. It should be noted that the game sound for terminal device may be a sound obtained by adding a BGM and the like to the ambient sounds.

Next, the CPU 5 generates a game sound for monitor to be outputted to the speaker 41 of the monitor 4 (step 73), and proceeds the processing to the next step. For example, the CPU 5 generates a whole sound generated in the whole virtual game space as the game sound for monitor. As one example, the CPU 5 synthesizes game sounds (voices of objects, an action sound, and sound effects, and the like) generated from the respective sound sources set on the game field in the virtual game space to generate the game sound for monitor. It should be noted that the game sound for monitor may be a sound obtained by adding a BGM and the like to the whole sound.

Next, the CPU 5 transmits the game image for terminal device and the game sound for terminal device to the terminal device 2 (step 74), and proceeds the processing to the next step. For example, the game image for terminal device is received by the terminal device 2 and outputted to the LCD 11 and displayed on the LCD 11. Further, the game sound for terminal device is received by the terminal device 2 and outputted from the speaker 12. It should be noted that a predetermined compression process may be performed when the game image for terminal device is transmitted from the information processing apparatus 3 to the terminal device 2. In this case, data of the game image for terminal device subjected to the compression process is transmitted to the terminal device 2. The terminal device 2 performs a predetermined decompression process, and then displays the game image for terminal device.

Next, the CPU 5 outputs the game image for monitor and the game sound for monitor to the monitor 4 (step 75), and proceeds the processing to the next step. For example, the game image for monitor is obtained by the monitor 4 and outputted to a display screen of the monitor 4 and displayed on the display screen. Further, the game sound for monitor is obtained by the monitor 4 and outputted from the speaker 41.

Next, the CPU 5 determines whether to end the game (step 76). For example, the CPU determines to end the game, when a condition for game over is satisfied; a condition for clearing the game is satisfied; or the user performs an operation to end the game. When the CPU 5 determines not to end the game, the CPU 5 returns to step 62 and repeats the processing. Meanwhile, when the CPU 5 determines to end the game, the CPU 5 ends the processing of the flow charts. Thereafter, a series of processes in step 62 to step 76 are repeated until the CPU 5 determines to end the game in step 76.

In the exemplary embodiment described above, the information processing system 1 includes a single terminal device 2. However, the information processing system 1 may include a plurality of terminal devices 2. That is, the information processing apparatus 3 may be wirelessly communicable with each of the plurality of terminal devices 2, may transmit image data to each terminal device 2 and receive terminal operation data from each terminal device 2. Then, the first virtual camera of each terminal device 2 may be positioned in the virtual game space, an orientation and a position of each first virtual camera may be controlled in accordance with an orientation of the corresponding terminal device 2 and an operation performed on the operation unit 13, and an image of the virtual game space seen from each first virtual camera may be transmitted to the corresponding terminal device 2. It should be noted that the information processing apparatus 3, which performs wireless communication with each of the plurality of terminal devices 2, may then perform wireless communication with each terminal device 2 in a time division manner or in a frequency division manner.

Further, the terminal device 2 described above function as a so-called thin client terminal, which does not perform the series of processes described using FIG. 7 and FIG. 8 or information processing similar to that performed by the information processing apparatus 3. For example, when the information processing is performed by a plurality of information processing apparatuses, it is necessary to synchronize processes performed by the respective information processing apparatus, resulting in complicating the processes. On the other hand, as in the above exemplary embodiment, when the single information processing apparatus 3 performs the information processing and the terminal device 2 receives and displays an image (that is, when the terminal device 2 is a thin client terminal), there is no need to synchronize processes between the plurality of information processing apparatus and thus the processes can be simplified. However, the terminal device 2 may be an apparatus such as, for example, a hand-held game apparatus, having a function of performing predetermined information processing (game process) by a predetermined program (game program). In this case, among the series of processes performed by the information processing apparatus 3 in the above exemplary embodiment, at least a part of the processes may be performed by the terminal device 2. As one example, when game images are displayed on a plurality of terminal devices, respectively, by using at least one or more terminal devices which can perform the entire series of processes described above, one of the terminal devices which can perform the entire series of processes performs the series of processes as a main processing device, and the main processing device transmits, to the other terminal devices, a game image based on orientations and operations of the respective other terminal devices, and thereby the similar game image can be outputted to each terminal device and displayed on the terminal device.

Further, in the description above, a case is used as an example where the information processing apparatus 3 performs the information processing (game process). However, at least a part of the process steps in the processing may be performed by another device other than the terminal device 2. For example, when the information processing apparatus 3 is configured so as to be communicable with other devices (e.g., another server, another game apparatus, and another mobile terminal) other than the terminal device 2, the process steps in the processing may be performed by collaboration of the other devices. As one example, a virtual game space and a sound may be generated and a game process may be performed using the virtual game space in the other devices, and a result of the game process may be displayed on the terminal device 2 and the monitor 4. In this manner, also when at least a part of the process steps in the above processing is performed by the other apparatus, the processing similar to the above described processing can be performed. Further, the above described display can be performed by one processor or by a cooperation of a plurality of processors included in an information processing system formed by at least one information processing apparatus. In the above exemplary embodiment, the processes in the above flow charts are performed by the CPU 5 of the information processing apparatus 3 performing a predetermined program. However, a part or the whole of the above processing may be performed by a dedicated circuit included in the information processing apparatus 3.

Here, according to the modification described above, the exemplary embodiment can be realized by a cloud computing system, a distributed wide area network system, or a distributed local network system. For example, in the distributed local network system, the above processing can be performed by collaboration of a stationary information processing apparatus (stationary game apparatus) and a hand-held information processing apparatus (hand-held game apparatus). It should be noted that, in these system configurations, there is no limitation to which device should perform which of the respective process steps in the processing described above. It is understood that the exemplary embodiment can be realized regardless of how the processing is shared and executed.

Further, the order of process steps, the setting values, the conditions for determinations, and the like used in the game process described above are examples only. It is understood that other order of process steps, other setting values, and conditions for determinations may be used for realizing the exemplary embodiment.

Furthermore, the program may be supplied to the information processing apparatus 3 not only via an external storage medium an external memory, but also via a wired or wireless communication line. Furthermore, the program may be stored in advance in a nonvolatile storage unit in information processing apparatus 3. The information storage medium for storing the program may be a CD-ROM, a DVD, a like optical disc-shaped storage medium, a flexible disc, a hard disk, a magneto-optical disc, or a magnetic tape, other than a nonvolatile memory. The information storage medium for storing the above program may be a volatile memory for storing the program. Such a storage medium may be a storage medium which can be read by a computer and the like. For example, by loading a program in such a storage medium into a computer and the like and causing the computer and the like to execute the program, the functions described above can be provided.

The systems, devices and apparatuses described herein may include one or more processors, which may be located in one place or distributed in a variety of places communicating via one or more networks. Such processor(s) can, for example, use conventional 3D graphics transformations, virtual camera and other techniques to provide appropriate images for display. By way of example and without limitation, the processors can be any of: a processor that is part of or is a separate component co-located with the stationary display and which communicates remotely (e.g., wirelessly) with the movable display; or a processor that is part of or is a separate component co-located with the movable display and communicates remotely (e.g., wirelessly) with the stationary display or associated equipment; or a distributed processing arrangement some of which is contained within the movable display housing and some of which is co-located with the stationary display, the distributed portions communicating together via a connection such as a wireless or wired network; or a processor(s) located remotely (e.g., in the cloud) from both the stationary and movable displays and communicating with each of them via one or more network connections; or any combination or variation of the above.

The processors can be implemented using one or more general-purpose processors, one or more specialized graphics processors, or combinations of these. These may be supplemented by specifically-designed ASICs (application specific integrated circuits) and/or logic circuitry. In the case of a distributed processor architecture or arrangement, appropriate data exchange and transmission protocols are used to provide low latency and maintain interactivity, as will be understood by those skilled in the art.

Similarly, program instructions, data and other information for implementing the systems and methods described herein may be stored in one or more on-board and/or removable memory devices. Multiple memory devices may be part of the same device or different devices, which are co-located or remotely located with respect to each other.

While some system examples, method examples, device examples, and apparatus examples have been described in detail, the foregoing description is in all aspects illustrative and not restrictive. It is to be understood that numerous other modifications and variations can be devised without departing from the spirit and scope of the appended claims. It is also to be understood that the scope of the exemplary embodiment is indicated by the appended claims rather than by the foregoing description. It is also to be understood that the detailed description herein enables one skilled in the art to make changes coming within the meaning and equivalency range of the exemplary embodiment. It is to be understood that as used herein, the singular forms used for elements and the like with “a” or “an” are not intended to exclude the plural forms thereof. It should be also understood that the terms as used herein have definitions typically used in the art unless otherwise mentioned. Thus, unless otherwise defined, all scientific and technical terms used herein have the same meanings as those generally used by those skilled in the art to which the exemplary embodiment pertains. If there is contradiction, the present specification (including the definitions) precedes.

As described above, the objective of the exemplary embodiment is such as to, when game images are displayed on a plurality of display devices including a portable display device, respectively, display appropriate images on the display devices, respectively, and the exemplary embodiment is useful as, for example, a game program, a game apparatus, a game system, a game processing method, and the like.

What is claimed is:

1. A computer-readable storage medium having stored therein a game program to be executed by a computer included in an apparatus which displays game images at least on a portable first display device and a second display device different from the first display device, respectively, the game program causing the computer to execute:
generating a first game image of a game space seen from a first-person viewpoint of a player object positioned in the game space;
generating a second game image of the game space seen from a fixed predetermined viewpoint in the game space;
displaying the first game image on the first display device; and
displaying the second game image on the second display device.

2. The computer-readable storage medium having stored therein the game program according to claim 1, wherein
the first display device includes a sensor which outputs data in accordance with a movement or an orientation of the first display device, and
when the first game image is generated, at least a view direction in which the game space is seen from the first-person viewpoint is set in accordance with the orientation of the first display device calculated based on the data outputted from the sensor.

3. The computer-readable storage medium having stored therein the game program according to claim 2, wherein
the first display device further includes an operation unit having a direction instruction unit for performing a direction instruction based on an operation by a user, and
when the first game image is generated, the view direction can be set in which the game space is seen from the first-person viewpoint in accordance with a direction instruction operation performed on the direction instruction unit, and
when the first game image is generated, selection is made to perform one of: setting the view direction in accordance with the orientation of the first display device based on the operation performed on the operation unit; and setting the view direction in accordance with the direction instruction operation.

4. The computer-readable storage medium having stored therein the game program according to claim 1, wherein
the first display device includes a direction instruction unit for performing a direction instruction based on an operation of a user, and
when the first game image is generated, at least a view direction is set in which the game space is seen from the first-person viewpoint in accordance with a direction instruction operation performed on the direction instruction unit.

5. The computer-readable storage medium having stored therein the game program according to claim 1, wherein
the first display device includes a first speaker, and
the game program further causes the computer to execute:
generating an ambient sound around the player object in the game space based on a position and/or a direction of the player object in the game space; and
controlling so that the generated ambient sound is outputted from the first speaker.

6. The computer-readable storage medium having stored therein the game program according to claim 1, wherein
the second display device is a stationary display device, and
when the second game image is generated, an image of the entire game space seen from the fixed viewpoint is generated as the second game image.

7. The computer-readable storage medium having stored therein the game program according to claim 6, wherein when the second game image is generated, an image of the game space including the player object is generated as the second game image.

8. The computer-readable storage medium having stored therein the game program according to claim 7, wherein
the first display device includes a sensor which outputs data in accordance with a movement or an orientation of the first display device, and
the computer is further caused to execute changing the position or the orientation of the player object in accordance with the movement or the orientation of the first display device calculated based on the data outputted from the sensor, and
when the second game image is generated, an image of the game space including the player object positioned in the game space in accordance with the position or the orientation having been changed is generated as the second game image.

9. The computer-readable storage medium having stored therein the game program according to claim 7, wherein
the first display device includes a direction instruction unit for performing a direction instruction based on an operation of a user, and
the computer is further caused to execute changing the position or the orientation of the player object in accordance with a direction instruction performed using the direction instruction unit, and
when the second game image is generated, an image of the game space including the player object positioned in the game space in accordance with the position or the orientation having been changed is generated as the second game image.

10. The computer-readable storage medium having stored therein the game program according to claim 6, wherein
the second display device includes a second speaker, and
the game program further causes the computer to execute:
generating a whole sound generated in the whole game space; and
controlling so that the generated whole sound is outputted from the second speaker.

11. The computer-readable storage medium having stored therein the game program according to claim 1, wherein the first-person viewpoint is a viewpoint from which the player object sees.

12. A game apparatus which displays game images at least on a portable first display device and a second display device different from the first display device, respectively, the game apparatus comprising:
a first game image generation unit which generates a first game image of a game space seen from a first-person viewpoint of a player object positioned in the game space;
a second game image generation unit which generates a second game image of the game space seen from a fixed predetermined viewpoint in the game space;
a first display control unit which displays the first game image on the first display device; and
a second display control unit which displays the second game image on the second display device.

13. A game system which includes a plurality of devices communicable with each other, and displays game images at least on a portable first display device and a second display device different from the first display device, respectively, the game system comprising:
a first game image generation unit which generates a first game image of a game space seen from a first-person viewpoint of a player object positioned in the game space;
a second game image generation unit which generates a second game image of the game space seen from a fixed predetermined viewpoint in the game space;
a first display control unit which displays the first game image on the first display device; and
a second display control unit which displays the second display device on the second game image.

14. A game processing method to be executed by a single processor or collaboration of a plurality of processors included in a system which includes at least one information processing apparatus capable of displaying game images at least on a portable first display device and a second display device different from the first display device, respectively, the game processing method comprising:
generating a first game image of a game space seen from a first-person viewpoint of a player object positioned in the game space;
generating a second game image of the game space seen from a fixed predetermined viewpoint in the game space;
displaying the first game image on the first display device; and
displaying the second game image on the second display device.
